(19) United States
(12) Patent Application Publication
(10) Pub. No.: US 2026/0030857 A1
(43) Pub. Date: Jan. 29, 2026

(54) APPARATUS AND SYSTEM FOR DETECTING HIDDEN OBJECT BASED ON ARTIFICIAL INTELLIGENCE LEARNING MODEL USING THz SCAN IMAGE

(71) Applicant: PANOPTICS Corp., Seongnam-si Gyeonggi-do (KR)

(72) Inventors: Jang Sun KIM, Seongnam-si Gyeonggi-do (KR); Su Young CHO, Yongin-si Gyeonggi-do (KR); Yi Seob KIM, Osan-si Gyeonggi-do (KR); Sang Ju KO, Anyang-si Gyeonggi-do (KR); Sun Jae KIM, Anyang-si Gyeonggi-do (KR); Minwoo PARK, Yongin-si Gyeonggi-do (KR); Ji Hoon CHA, Seoul (KR); Kyeong Lyeol LIM, Incheon (KR); Dae Yeon KIM, Hwaseong-si Gyeonggi-do (KR)

(73) Assignee: PANOPTICS Corp., Seongnam-si Gyeonggi-do (KR)

(21) Appl. No.: 19/346,846

(22) Filed: Oct. 1, 2025

Related U.S. Application Data
(63) Continuation of application No. PCT/KR2024/004018, filed on Mar. 29, 2024.

(30) Foreign Application Priority Data
Apr. 4, 2023 (KR) 10-2023-0044160

(51) Int. Cl. G06V 10/143; G06T 7/194; G06T 11/60

(52) U.S. Cl. CPC G06V 10/143; G06T 7/194; G06T 11/60; G06T 2207/10048; G06T 2207/20084; G06T 2207/20221; G06V 2201/07

(57) ABSTRACT

Disclosed are artificial intelligence learning model-based hidden object detection apparatus and system. The hidden object detection apparatus and system can accurately and conveniently detect a hidden object concealed by an inspection target by using various types of photographing devices and an artificial intelligence learning model trained to detect a hidden object from images taken by the photographing devices.

### CROSS-REFERENCE TO RELATED APPLICATIONS

The present application is a continuation of International Application No. PCT/KR2024/004018 filed on Mar. 29, 2024, which claims priority under 35 U.S.C. § 119 (a) to Korean Patent Application No. 10-2023-0044160, filed in the Korean Intellectual Property Office on Apr. 4, 2023, the entire disclosure of which is incorporated herein by reference.

### BACKGROUND

### 1. Technical Field

The present disclosure relates to a hidden object detection apparatus based on an artificial intelligence learning model by using a THz scan image, and a system including the same.

### 2. Related Art

Contents described in this part merely provide background information of the present embodiment, and do not constitute a conventional technology.

Various cameras are used to obtain image information on the surroundings. For example, there are CCD/CMOS cameras using visible light, infrared cameras using infrared light, and the like. The CCD cameras are a type of digital cameras, and store digital data in storage media such as a flash memory by converting images into electrical signals by using a charge-coupled device (CCD). The CCD cameras are mainly used in the daytime, and the infrared cameras are mainly used at night.

In general, typical metal detectors are installed in airports or various conference halls in order to detect metallic objects such as firearms and prevent the entry of hazardous materials. The metal detectors use an electromagnetic induction phenomenon and are devices that detect firearms or other metallic hazardous materials by using the property of a magnetic field changing depending on the presence or absence of metallic objects.

The metal detectors are classified into a portable metal detector, which is carried by a safety officer to detect whether a visitor possesses metals, and a gate-type metal detector that uses a gate-type structure and detects metals possessed by a visitor passing through the gate-type structure. However, such metal detectors have problems in that they are not able to detect non-metals and inaccurately detect metals due to external noise, and are inconvenient because a safety officer or the like perform a physical inspection on all visitors one by one.

X-ray detectors are a representative hidden object detection apparatus used in airports and the like requiring security screening. However, the X-ray detectors may violate human rights by clearly displaying the body under clothing, and may have an adverse influence on the body because the body is irradiated with X-rays during screening.

In this regard, a method using THz images is being recently considered. THz waves are electromagnetic waves in the region between infrared rays and microwaves, and have both the linearity of infrared light and the penetrability of microwaves. Accordingly, THz waves can not only penetrate most non-metallic materials like microwaves, but also provide fine spatial resolution unlike microwaves.

However, since THz waves have excellent resolution for stationary objects, but do not have sufficient resolution for analyzing moving objects, they still have shortcomings when used for hidden object inspection.

### SUMMARY

Embodiments of the present disclosure are directed to providing hidden object detection apparatus and system that can accurately and conveniently detect a hidden object concealed by an inspection target by using various types of photographing devices and an artificial intelligence learning model trained to detect a hidden object from images taken by the photographing devices.

According to an aspect of the present embodiment, a hidden object detection apparatus that detects whether a visitor possesses a hidden object includes: a communication unit configured to receive a terahertz-wave image, a thermal image, and a visible-light image of a visitor from an exterior and to receive information on a distance to the visitor; a pre-processing unit configured to pre-process the terahertz-wave image; a memory unit configured to store a first learning model trained using, as an input value, the terahertz-wave image and, as an output value, various hidden objects present in the terahertz-wave image and a second learning model trained using, as an input value, the thermal image and, as an output value, various hidden objects present in the thermal image; a hidden object detection unit configured to use the first learning model and the second learning model to detect a hidden object possessed by the visitor from the pre-processed terahertz-wave image and the thermal image; and an image processing unit configured to combine the detected hidden object with the image of the visitor in the visible-light image.

According to an aspect of the present embodiment, the pre-processing unit pre-processes the terahertz-wave image by using the received information on the distance.

According to an aspect of the present embodiment, the pre-processing unit adjusts formats of the terahertz-wave image and the thermal image.

According to an aspect of the present embodiment, the first learning model and the second learning model are trained using each input value and each output value by using a convolutional neural network (CNN) or a multi-layer perceptron (MLP).

According to an aspect of the present embodiment, the hidden object detection apparatus further includes an output unit configured to output an image combined by the image processing unit.

According to an aspect of the present embodiment, a hidden object detection system that detects whether a visitor possesses a hidden object includes: a terahertz-wave camera configured to capture an image of a visitor; a thermal imaging camera configured to capture the image of the visitor; a visible-light camera configured to capture the image of the visitor; a depth camera configured to acquire information on a distance from the depth camera to the visitor; and a hidden object detection apparatus configured to receive a terahertz-wave image of the visitor, a thermal image of the visitor, a visible-light image of the visitor, and the information on a distance to the visitor from the terahertz-wave camera, the thermal imaging camera, the visible-light camera, and the depth camera, respectively, and to detect whether the visitor possesses a hidden object.

According to an aspect of the present embodiment, the hidden object detection apparatus includes: a communication unit configured to receive the terahertz-wave image of the visitor, the thermal image of the visitor, the visible-light image of the visitor from an exterior, and the information on a distance to the visitor; a pre-processing unit configured to pre-process the terahertz-wave image; a memory unit configured to store a first learning model trained using, as an input value, the terahertz-wave image and, as an output value, various hidden objects present in the terahertz-wave image and a second learning model trained using, as an input value, the thermal image and, as an output value, various hidden objects present in the thermal image; a hidden object detection unit configured to use the first learning model and the second learning model to detect the hidden object possessed by the visitor from the pre-processed terahertz-wave image and thermal image; and an image processing unit configured to combine the detected hidden object with the image of the visitor in the visible-light image.

According to an aspect of the present embodiment, the image processing unit removes a background excluding the visitor from the visible-light image received from the visible-light camera.

According to an aspect of the present embodiment, the image processing unit extracts only the hidden object detected by the hidden object detection unit from the terahertz-wave image or the thermal image.

According to an aspect of the present embodiment, the image processing unit combines the extracted hidden object with the visible-light image with the background removed.

As described above, an aspect of the present embodiment has advantages in that a hidden object concealed by an inspection target can be accurately and conveniently detected by using various types of photographing devices and an artificial intelligence learning model trained to detect a hidden object from images taken by the photographing devices.

### BRIEF DESCRIPTION OF THE DRAWINGS

FIGS. 1A and 1B are plan views illustrating a configuration of a hidden object detection system according to an embodiment of the present disclosure.

FIG. 2 is a diagram illustrating a configuration of a hidden object detection apparatus according to an embodiment of the present disclosure.

FIGS. 3A and 3B are diagrams illustrating terahertz-wave images before and after being pre-processed by a pre-processing unit according to an embodiment of the present disclosure.

FIG. 4 is a diagram illustrating a state in which a hidden object detection unit according to an embodiment of the present disclosure detects a hidden object from a terahertz-wave image.

FIG. 5 is a diagram illustrating a state in which the hidden object detection unit according to an embodiment of the present disclosure detects a hidden object from a thermal image.

FIGS. 6A and 6B are diagrams illustrating a state in which an image processing unit according to an embodiment of the present disclosure removes a background from a visible-light image.

FIG. 7 is a diagram illustrating an image processed into a final output format by the image processing unit according to an embodiment of the present disclosure.

FIG. 8 is a diagram illustrating a method in which the hidden object detection apparatus according to an embodiment of the present disclosure detects and outputs a hidden object.

### DETAILED DESCRIPTION

The present disclosure may be changed in various ways and may have various embodiments. Specific embodiments are to be illustrated in the drawings and specifically described. It should be understood that the present disclosure is not intended to be limited to the specific embodiments, but includes all of changes, equivalents and/or substitutions included in the spirit and technical range of the present disclosure. Similar reference numerals are used for similar components while each drawing is described.

Terms, such as a first, a second, A, and B, may be used to describe various components, but the components should not be restricted by the terms. The terms are used to only distinguish one component from another component. For example, a first component may be referred to as a second component without departing from the scope of rights of the present disclosure. Likewise, a second component may be referred to as a first component. The term “and/or” includes a combination of a plurality of related and described items or any one of a plurality of related and described items.

When it is described that one component is “connected” or “coupled” to the other component, it should be understood that one component may be directly connected or coupled to the other component, but a third component may exist between the two components. In contrast, when it is described that one component is “directly connected to” or “directly coupled to” the other component, it should be understood that a third component does not exist between the two components.

Terms used in this application are used to only describe specific embodiments and are not intended to restrict the present disclosure. An expression of the singular number includes an expression of the plural number unless clearly defined otherwise in the context. In this specification, a term, such as “include” or “have”, is intended to designate the presence of a characteristic, a number, a step, an operation, a component, a part described in this specification or a combination of them, and it should be understood that it does not exclude the possibility of the existence or addition of one or more other characteristics, numbers, steps, operations, components, parts, or combinations of them in advance.

All terms used herein, including technical or scientific terms, have the same meanings as those commonly understood by a person having ordinary knowledge in the art to which the present disclosure pertains, unless defined otherwise in the specification.

Terms, such as those defined in commonly used dictionaries, should be construed as having the same meanings as those in the context of a related technology, and are not construed as ideal or excessively formal meanings unless explicitly defined otherwise in the application.

Furthermore, each construction, process, procedure, or method included in each embodiment of the present disclosure may be shared within a range in which the constructions, processes, procedures, or methods do not contradict each other technically.

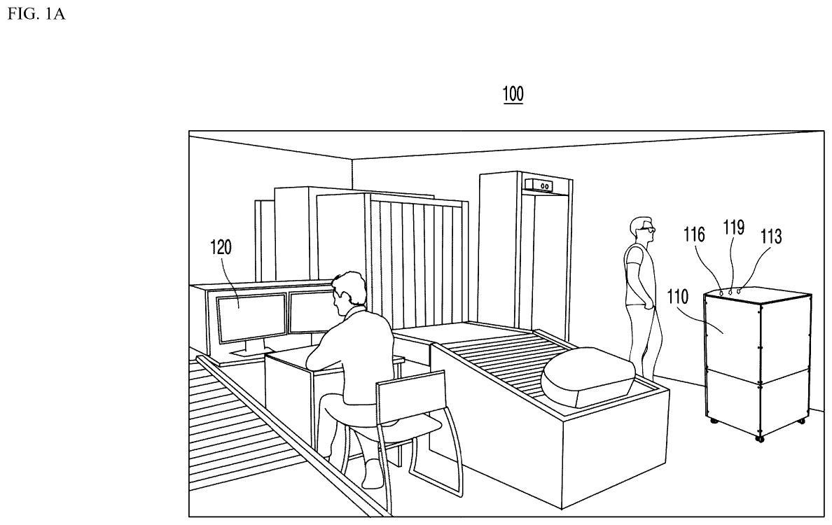

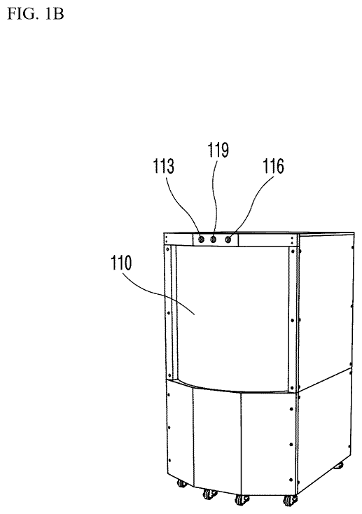

FIGS. 1A and 1B are plan views illustrating a configuration of a hidden object detection system according to an embodiment of the present disclosure.

Referring to FIGS. 1A and 1B, a hidden object detection system 100 according to an embodiment of the present disclosure includes a terahertz-wave camera 110, a depth camera 113, a thermal imaging camera 116, a visible-light camera 119, and a hidden object detection apparatus 120.

The hidden object detection system 100 is installed in locations where it is necessary to detect whether visitors possess hidden objects (prohibited items), such as airports, hospitals, or public places with large crowds, and detects whether the visitors possess the hidden objects in a non-contact manner. The hidden object detection system 100 can relatively accurately detect whether the visitors possess the hidden objects in a state, in which the visitors walk at a normal walking speed, without the need of stopping the visitors to detect whether the visitors possess the hidden objects.

The cameras 110, 113, 116, and 119 are disposed to capture images of the visitors along movement paths of the visitors, and transmit the captured images to the hidden object detection apparatus 120. As described in the background technology of the disclosure, the terahertz-wave camera 110 acquires the images of the visitors by using terahertz waves. The thermal imaging camera 116 and the visible-light camera 119 acquire a thermal image and a typical visible-light image, respectively, and the depth camera 113 captures the distance between the visitor and the camera (e.g., 113). The cameras 110, 113, 116, and 119 transmit the captured images to the hidden object detection apparatus 120, thereby allowing the hidden object detection apparatus 120 to detect whether the visitors possess hidden objects.

The hidden object detection apparatus 120 receives the images or distance information from the cameras 110, 113, 116, and 119, analyzes the received images to detect whether the visitors possess the hidden objects, and outputs an image highlighting the detected hidden object.

The hidden object detection apparatus 120 receives the images from the cameras 110, 113, 116, and 119, and detects whether the visitors possess the hidden objects by using the terahertz-wave image and the thermal image. The hidden object detection apparatus 120 stores an artificial intelligence learning model trained using each image as an input value and whether the visitors possess the hidden objects as an output value. The hidden object detection apparatus 120 detects the hidden objects within the terahertz-wave image and the thermal image by using the stored learning model.

The hidden object detection apparatus 120 outputs an image highlighting the detected hidden object. When outputting the image, the hidden object detection apparatus 120 primarily uses the image of the visitor captured in the visible-light image, extracts only the hidden object detected from each image, and outputs the image in the form of combining the extracted hidden object with the image of the visitor. When the terahertz-wave image or the thermal image is output as it is, since the outline of the visitor's body is clearly visible, there are concerns about violations of individual human rights. The hidden object detection apparatus 120 uses the images during the hidden object detection process, and when finally outputting the image to the outside (when there is a hidden object), the hidden object detection apparatus 120 combines only a detected hidden object and outputs a combined result, thereby solving the aforementioned concerns.

In FIGS. 1A and 1B, the depth camera 113 is depicted in the form of a camera; however, the present disclosure is not limited thereto and the depth camera 113 may be replaced with any means (e.g., a sensor) capable of measuring the distance between the depth camera 113 and a visitor.

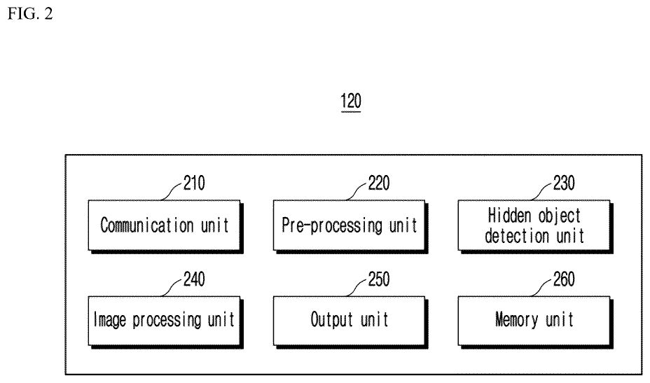

FIG. 2 is a diagram illustrating a configuration of the hidden object detection apparatus according to an embodiment of the present disclosure.

Referring to FIG. 2, the hidden object detection apparatus 120 according to an embodiment of the present disclosure includes a communication unit 210, a pre-processing unit 220, a hidden object detection unit 230, an image processing unit 240, an output unit 250, and a memory unit 260. The hidden object detection apparatus 120 may include a hardware processor. The communication unit 210, the pre-processing unit 220, the hidden object detection unit 230, and the image processing unit 240 may be a part of the hardware processor or a program module executed by the hardware processor. The output unit 250 may be a screen or a display device.

The communication unit 210 receives the images or distance information from the cameras 110, 113, 116, and 119. The communication unit 210 receives a terahertz-wave image from the terahertz-wave camera 110, a thermal image from the thermal imaging camera 116, and a visible-light image from the visible-light camera 119. In addition, the communication unit 210 receives information on a distance from the depth camera 113 to a camera of the visitor.

The pre-processing unit 220 adjusts the format of the received image, removes noise within the image, and pre-processes the terahertz-wave image by using the distance information.

When a format of an image as an input value for detecting a hidden object is different from the format (size etc.) of the image received by the communication unit 210, the pre-processing unit 220 adjusts the format of the received image. For example, when the size or resolution required as an input value of an artificial intelligence learning model is different from that of the received image, the pre-processing unit 220 adjusts the size or resolution of the received image to match the size or resolution required as the input value of the learning model. In addition, when removeable noise occurs in the image during transmission between the cameras 110, 116, 119 and the communication unit 210 or in other various situations, the pre-processing unit 220 removes the noise.

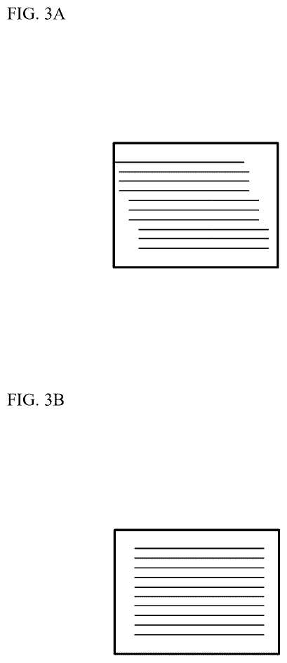

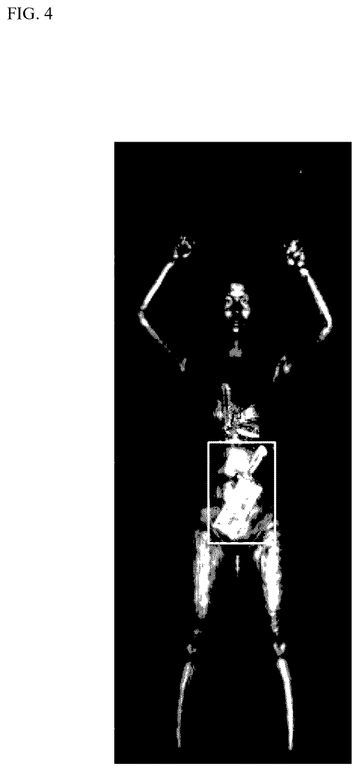

In addition, the pre-processing unit 220 pre-processes the terahertz-wave image by using the distance information received from the depth camera 113. The terahertz-wave image is taken in the form illustrated in FIGS. 3A and 3B.

FIGS. 3A and 3B are diagrams illustrating terahertz-wave images before and after being pre-processed by the pre-processing unit according to an embodiment of the present disclosure

Referring to FIG. 3A, the terahertz-wave camera 110 operates as a line camera. That is, the terahertz-wave camera 110 generates one row of pixels or one line within the image, and then generates the next row or line. When a visitor is stationary, a terahertz-wave image generated by the aforementioned operation of the terahertz-wave camera 110 has no problems. However, as described above, when a terahertz-wave image is generated while the visitor is moving, a problem occurs as illustrated in FIG. 3A. The movement speed of the visitor causes a distortion in the terahertz-wave image. The pre-processing unit 220 analyzes the location (distance) of the visitor at each shooting point of the depth camera 113 by using the distance information received from the depth camera 113, thereby analyzing the degree of distortion in the terahertz-wave image. When the location information of the visitor is known, the distortion in the terahertz-wave image can be compensated for. As illustrated in FIG. 3B, the pre-processing unit 220 pre-processes the terahertz-wave image by using the distance information received from the depth camera 113.

Referring again to FIG. 2, the hidden object detection unit 230 detects a hidden object possessed by the visitor by using the pre-processed terahertz-wave image and the received thermal image.

The hidden object detection unit 230 uses an artificial intelligence learning model stored in the memory unit 260 in order to detect the hidden object. A first learning model corresponds to a model that uses a terahertz-wave image as an input value and various hidden objects (anything other than the body, clothing, and accessories) within the terahertz-wave image as an output value and is trained using numerous input values and output values by using a learning model algorithm suitable for image processing, such as a convolutional neural network (CNN) or a multi-layer perceptron (MLP). A second learning model corresponds to a model that uses a thermal image as an input value and various hidden objects within the thermal image as an output value, and is trained using numerous input values and output values by using the aforementioned learning model algorithm.

As illustrated in FIG. 4, the hidden object detection unit 230 inputs the terahertz-wave image pre-processed by the pre-processing unit 220 into the first learning model to detect whether a hidden object is present within the terahertz-wave image.

FIG. 4 is a diagram illustrating a state in which the hidden object detection unit according to an embodiment of the present disclosure detects a hidden object from the terahertz-wave image.

As illustrated in FIG. 4, the hidden object detection unit 230 inputs the terahertz-wave image pre-processed by the pre-processing unit 220 as an input value for the first learning model. Accordingly, when the visitor possesses a hidden object, the hidden object detection unit 230 detects the hidden object in the terahertz-wave image.

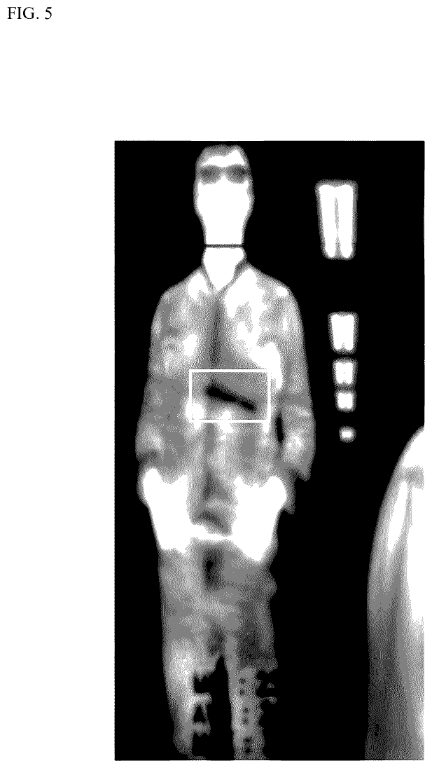

Referring again to FIG. 2, as illustrated in FIG. 5, the hidden object detection unit 230 inputs the received thermal image into the second learning model to detect whether a hidden object is present in the hidden object image.

FIG. 5 is a diagram illustrating a state in which the hidden object detection unit according to an embodiment of the present disclosure detects a hidden object from the thermal image.

As illustrated in FIG. 5, the hidden object detection unit 230 inputs the received thermal image as an input value for the second learning model. Accordingly, when the visitor possesses a hidden object, the hidden object detection unit 230 detects the hidden object in the thermal image. In particular, the hidden object detection unit 230 detects the visitor in the thermal image, and then detects a portion or a component within the body of the visitor, which is relatively cooler or warmer than the surroundings. The visitor in the thermal image, particularly, the head of the visitor maintains a constant temperature regardless of the season or environment. In particular, while the body temperature of the visitor may vary in summer or winter, the head maintains a constant temperature because a coat or the like is worn on the head. The hidden object detection unit 230 can detect the head of the visitor in this manner to detect the entire body of the visitor. The hidden object detection unit 230 detects the visitor according to the aforementioned process, and detects a portion of the body of the visitor, which is relatively warmer or cooler than the surroundings. Through such a process, the hidden object detection unit 230 (or second learning model) can detect the hidden objects from the thermal image.

Referring again to FIG. 2, the hidden object detection unit 230 detects the hidden object from both the terahertz-wave image and the thermal image by using different learning models, respectively. When detecting the hidden object using only one learning model, the accuracy may be relatively low. In order to compensate for such a problem, the hidden object detection unit 230 detects the hidden object by using the learning models trained using images of different formats, thereby detecting the hidden object with higher accuracy.

On the other hand, the hidden object detection unit 230 can identify the temperature (body temperature) of the visitor while detecting the hidden object by using the thermal image. The hidden object detection unit 230 performs a visitor identification operation while detecting a hidden object by using the thermal image. Accordingly, the hidden object detection unit 230 can easily identify the temperature of a visitor. The hidden object detection unit 230 identifies the temperature of the visitor, and allows the output unit 250 to output the body temperature of the visitor when outputting the image processed by the image processing unit 240. This allows a watcher to ascertain not only whether the visitor possesses a hidden object, but also the body temperature, thereby allowing the visitor's physical condition (e.g., whether the visitor has an infectious disease).

The image processing unit 240 removes the background from the received visible-light image, extracts only the hidden object detected by the hidden object detection unit 230 from the terahertz-wave image or the thermal image, and combines the hidden object with the visible-light image with the background removed.

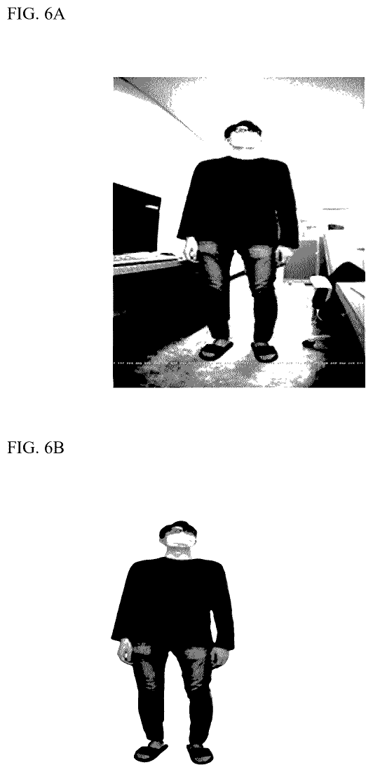

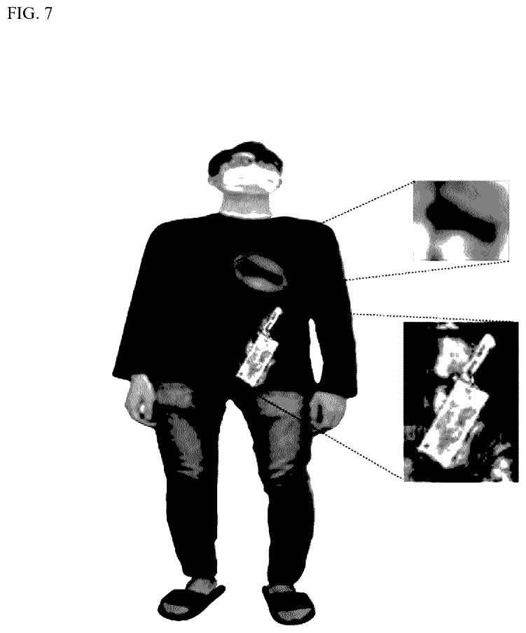

As illustrated in FIGS. 6A and 6B, the image processing unit 240 recognizes an object (visitor) in the visible-light image received from the visible-light camera 119, and removes the background other than the object.

FIGS. 6A and 6B are diagrams illustrating a state in which the image processing unit according to an embodiment of the present disclosure removes the background from the visible-light image.

Referring to FIGS. 6A and 6B, the image processing unit 240 recognizes an object (visitor) in the received visible-light image by using various object recognition algorithms or background removal algorithms, and removes the background other than the object. Accordingly, the image processing unit 240 allows only the visitor to be highlighted in an image to be finally output.

When the hidden object detection unit 230 detects the hidden object in one or both images (the terahertz-wave image or the thermal image), the image processing unit 240 extracts only the detected hidden object from the image. The hidden object detection unit 230 extracts the hidden object from the image by using various object extraction algorithms.

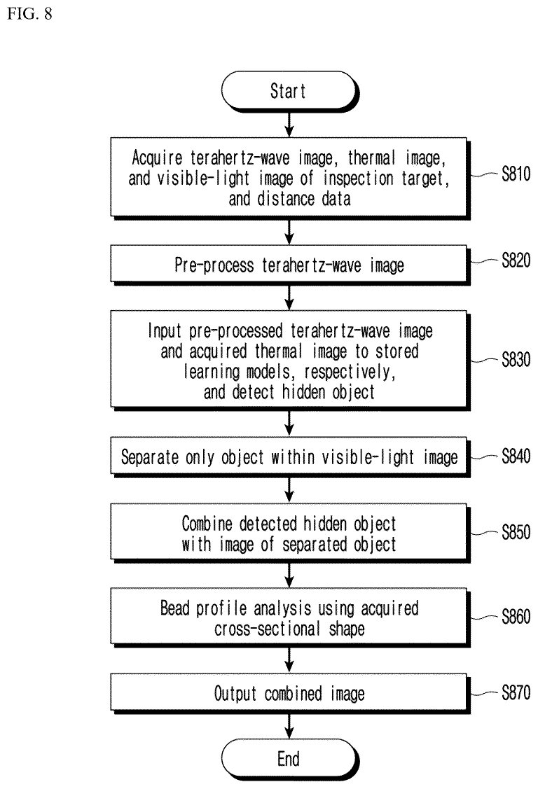

As illustrated in FIG. 7, the image processing unit 240 combines the extracted hidden object with the visible-light image with the background removed.

FIG. 7 is a diagram illustrating an image processed into a final output format by the image processing unit according to an embodiment of the present disclosure.

Referring to FIG. 7, the image processing unit 240 combines the extracted hidden object into a location corresponding to the location, where the hidden object is present in the terahertz-wave image or the thermal image, within the visible-light image with the background removed. This improves the visibility of an image to be output, and only the hidden object is output from the terahertz-wave image or the thermal image, thereby resolving the issue of human rights violations against individual visitors. The watcher, who monitors whether a visitor possesses a hidden object by using the hidden object detection apparatus 120, can conveniently identify the hidden object by checking the image processed by the image processing unit 240.

Referring again to FIG. 2, the output unit 250 outputs the image processed by the image processing unit 240. In order to allow the watcher to check whether the visitor possesses a hidden object, the output unit 250 outputs the image processed (combined) by the image processing unit 240.

The output unit 250 can also output the body temperature of the visitor ascertained by the hidden object detection unit 230 together with the image.

The memory unit 260 stores the first learning model and the second learning model.

FIG. 8 is a diagram illustrating a method in which the hidden object detection apparatus according to an embodiment of the present disclosure detects and outputs a hidden object.

The communication unit 210 acquires a terahertz-wave image, a thermal image, and a visible-light image of an inspection target, and distance data (S810).

The pre-processing unit 220 pre-processes the terahertz-wave image (S820). The pre-processing unit 220 pre-processes the terahertz-wave image itself and can additionally pre-process the terahertz-wave image by using the acquired distance data.

The hidden object detection unit 230 inputs the pre-processed terahertz-wave image and the acquired thermal image to the stored learning models, respectively, and detects a hidden object (S830).

The image processing unit 240 separates only an object within the visible-light image (S840).

The image processing unit 240 combines the detected hidden object with an image of the separated object (S850).

The output unit 250 outputs the combined image (S860).

In FIG. 8, the processes are described as being sequentially performed, but the above description is merely intended to illustratively describe the technical spirit of an embodiment of the present disclosure. In other words, since those skilled in the art to which an embodiment of the present disclosure pertains will be able to make and apply various corrections and modifications such as changing the order illustrated in each drawing or performing one or more of the processes in parallel, without departing from the essential features of on embodiment of the present disclosure, FIG. 8 is not limited to a chronological order.

The processes illustrated in FIG. 8 can be implemented with computer-readable codes on a computer-readable recording medium. The computer-readable recording medium includes all types of recording devices that store data readable by a computer system. That is, the computer-readable recording medium includes a storage medium such as a magnetic storage medium (e.g., ROM, floppy disk, hard disk, etc.) and an optical reading medium (e.g., CD-ROM, DVD, etc.). In addition, the computer-readable recording medium can be distributed in computer systems connected through a network, so that computer-readable codes can be stored and executed in a distributed manner.

The above description is merely a description of the technical spirit of the present embodiment, and those skilled in the art may change and modify the present embodiment in various ways without departing from the essential characteristic of the present embodiment. Accordingly, the embodiments should not be construed as limiting the technical spirit of the present embodiment, but should be construed as describing the technical spirit of the present embodiment. The scope of the technical spirit of the present embodiment is not restricted by the embodiments. The range of protection of the present embodiment should be construed based on the following claims, and all of technical spirits within an equivalent range of the present embodiment should be construed as being included in the scope of rights of the present embodiment.

This patent application claims priority pursuant to Article 119(a) of the U.S. Patent Act (35 U.S.C § 119(a)) over Korean Patent Application No. 10-2023-0044160 filed in Korea on Apr. 4, 2023, the entire content of which is hereby incorporated into this patent application by reference. In addition, when this patent application claims priority for a country other than the United States for the same reasons as above, the entire content of which is hereby incorporated into this patent application by reference.

What is claimed is:

1. A hidden object detection apparatus that detects whether a visitor possesses a hidden object, the hidden object detection apparatus comprising:
a communication unit configured to receive a terahertz-wave image, a thermal image, and a visible-light image of a visitor from an exterior and to receive information on a distance to the visitor;
a pre-processing unit configured to pre-process the terahertz-wave image;
a memory unit configured to store a first learning model trained using, as an input value, the terahertz-wave image and, as an output value, various hidden objects present in the terahertz-wave image and a second learning model trained using, as an input value, the thermal image and, as an output value, various hidden objects present in the thermal image;
a hidden object detection unit configured to use the first learning model and the second learning model to detect a hidden object possessed by the visitor from the pre-processed terahertz-wave image and the thermal image; and
an image processing unit configured to combine the detected hidden object with the image of the visitor in the visible-light image.

2. The hidden object detection apparatus of claim 1, wherein the pre-processing unit pre-processes the terahertz-wave image by using the received information on the distance.

3. The hidden object detection apparatus of claim 1, wherein the pre-processing unit adjusts formats of the terahertz-wave image and the thermal image.

4. The hidden object detection apparatus of claim 1, wherein the first learning model and the second learning model are trained using each input value and each output value by using a convolutional neural network (CNN) or a multi-layer perceptron (MLP).

5. The hidden object detection apparatus of claim 1, further comprising:
an output unit configured to output an image combined by the image processing unit.

6. A hidden object detection system that detects whether a visitor possesses a hidden object, the hidden object detection system comprising:
a terahertz-wave camera configured to capture an image of a visitor;
a thermal imaging camera configured to capture the image of the visitor;
a visible-light camera configured to capture the image of the visitor;
a depth camera configured to acquire information on a distance from the depth camera to the visitor; and
a hidden object detection apparatus configured to receive a terahertz-wave image of the visitor, a thermal image of the visitor, a visible-light image of the visitor, and the information on a distance to the visitor from the terahertz-wave camera, the thermal imaging camera, the visible-light camera, and the depth camera, respectively, and to detect whether the visitor possesses a hidden object.

7. The hidden object detection system of claim 6, wherein the hidden object detection apparatus comprises:
a communication unit configured to receive the terahertz-wave image of the visitor, the thermal image of the visitor, the visible-light image of the visitor from an exterior, and the information on a distance to the visitor;
a pre-processing unit configured to pre-process the terahertz-wave image;
a memory unit configured to store a first learning model trained using, as an input value, the terahertz-wave image and, as an output value, various hidden objects present in the terahertz-wave image and a second learning model trained using, as an input value, the thermal image and, as an output value, various hidden objects present in the thermal image;
a hidden object detection unit configured to use the first learning model and the second learning model to detect the hidden object possessed by the visitor from the pre-processed terahertz-wave image and thermal image; and
an image processing unit configured to combine the detected hidden object with the image of the visitor in the visible-light image.

8. The hidden object detection system of claim 7, wherein the image processing unit removes a background excluding the visitor from the visible-light image received from the visible-light camera.

9. The hidden object detection system of claim 8, wherein the image processing unit extracts only the hidden object detected by the hidden object detection unit from the terahertz-wave image or the thermal image.

10. The hidden object detection system of claim 9, wherein the image processing unit combines the extracted hidden object with the visible-light image with the background removed.
